(19) United States
(12) Patent Application Publication
(10) Pub. No.: US 2021/0122509 A1
(43) Pub. Date: Apr. 29, 2021

(54) PACKAGED FOOD PRODUCT AND PROCESS AND PACKAGING THEREFOR

(71) Applicant: Kraft Foods Group Brands LLC, Chicago, IL (US)

(72) Inventors: Jonathan Wiese, Chicago, IL (US); Lauren Chard, Evanston, IL (US); Monica Maurtua, Chicago, IL (US); Allison Nowak, Morton Grove, IL (US); Kwaku Bandoh, Round Lake, IL (US); Michelle Cozo Pollard, Chicago, IL (US)

(21) Appl. No.: 17/083,519

(22) Filed: Oct. 29, 2020

Related U.S. Application Data
(60) Provisional application No. 62/927,300, filed on Oct. 29, 2019.

(51) Int. Cl. B65B 25/00; A23L 15/00; B65B 5/06; B65B 7/28

(52) U.S. Cl. CPC B65B 25/001; A23L 15/30; A23V 2002/00; B65B 7/2878; B65B 5/068

(57) ABSTRACT

A formed tray for baking and transporting a food product is provided herein. In some embodiments, the formed tray includes two cavities surrounded by a peripheral flange. In addition, the formed tray also may include a rigid bridge extending between the cavities and recessed below the peripheral flange. The peripheral flange of the formed tray may include beveled corners and two concave sections. A pre-cooked food product may be disposed in the cavities and sealed within the formed tray by a flexible film. Also provided herein is a process for baking and sealing a food product within the formed tray to provide a pre-cooked packaged food product that may be stored and transported.

### CROSS-REFERENCE TO RELATED APPLICATIONS

This application claims the benefit of U.S. Provisional Application No. 62/927,300, filed. Oct. 29, 2019, which is incorporated herein by reference in its entirety.

### TECHNICAL FIELD

This application relates generally to packaged food products, and more specifically to packaging and processes for preparing and baking a food product.

### BACKGROUND

Ready-to-eat or quickly prepared food has become increasingly popular with consumers over the years due to busy lifestyles and an increase in the variety of available, convenient food options. These quickly prepared food items include those that can be reheated in a microwave or toaster oven, among others. In addition to convenience, consumers are increasingly interested in nutritional meal options that are both time saving and provide portion control.

While quickly prepared foods are often desirable to consumers, such food requires careful preparation to ensure food safety considerations are addressed. Furthermore, consumers typically desire aesthetically pleasing product and food consumption experience. These desires are often limited by the packaging materials available. For example, packaging trays, such as, for example, crystallized polyethylene terephthalate (CPET) trays, are prone to warpage and deformation when they undergo baking or other heat-treatments. In addition to providing an unappealing appearance, this tray warpage often inhibits a sealing operation from forming a hermetic seal around the food product, which helps protect and preserve the final packaged product. Accordingly, this may necessitate baking or otherwise heat treating the food product (or portions thereof) in a separate vessel prior to packaging the product for delivery to and consumption by a consumer.

Baking and packaging in two separate trays may create process waste. Furthermore, baking the product in one tray then transferring the cooked product to separate packaging introduces a contamination risk. In the post-cook handling process, Listeria monocytogenes contamination is of particular concern. Listeria monocytogenes that may be present is killed by baking or other heat-treatment methods. Food products, however, can become re-contaminated after baking through the handling process in the processing plant. Transferring the cooked product from a baking tray to a separate packaging tray is one way in which post-bake contamination can be introduced to the baked food product. Accordingly, minimizing the post-cook handling may decrease the risk of post-cook re-contamination.

### BRIEF DESCRIPTION OF THE DRAWINGS

FIG. 1 is a front perspective view of one embodiment of a tray with two cavities therein.

FIG. 2 is a top plan view of the embodiment of FIG. 1.

FIG. 3 is a front elevational view of the embodiment of FIG. 1.

FIG. 4 is side elevational view of the embodiment of FIG. 1.

FIG. 5 a bottom plan view of the embodiment of FIG. 1.

FIG. 6 is a front perspective view of a packaged food product.

FIG. 7 is a diagram of a process for baking and sealing a food product in a formed tray.

FIG. 8 is a front perspective view of one embodiment of a tray with two cavities therein.

FIG. 9 is a top plan view of the embodiment of FIG. 8.

FIG. 10 is a front elevation view of the embodiment of FIG. 8.

FIG. 11 is a side elevation view of the embodiment of FIG. 8.

FIG. 12 is a bottom plan view of the embodiment of FIG. 8.

FIG. 13 is a system for making a food product in accordance with some embodiments described herein.

FIG. 14 is a process for making a food product in accordance with some embodiments described herein.

FIG. 15 is a partial perspective view illustrating a spray nozzle in accordance with some embodiments described herein.

FIG. 16 is a partial cross-sectional view illustrating the spray nozzle of FIG. 15.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments described herein, a food product, such as an egg product, is provided in a formed tray that can be baked, sealed, transported, and/or reheated (such as in a microwave), before consumption by a consumer. Also described herein are processes for preparing food products that are baked and sealed in a formed tray, such that the baked food product does not need to be transferred from the cooking vessel to separate product packaging. In this manner, a single tray may be employed for baking, sealed with lidding, and used for product storage, transport, and reheating. In one illustrative embodiment, the tray and lidding are designed to permit the food product to be cooked in the packaging. For example, the tray may be designed to prevent warpage during baking or other heat treatments so that the lidding may be hermetically sealed on the tray (such as at the tray flange) to provide a final packaged food product with a high degree of seal integrity.

In some approaches, the food product is a ready-to-heat product. In this form, the ready-to-heat food products have undergone initial thermal processing before being shipped so that the consumer need only quickly reheat the product, such as in a microwave oven, before consumption. In one aspect, the thermal processing is sufficient to achieve a minimum internal temperature of at least 185° F., in another aspect about 185° F. to about 200° F. In this respect, the product has sufficient microbial stability to be safely consumed from the package and prior to heating by the consumer.

In one embodiment, the packaged food product includes a tray with a flexible film sealed to a portion thereof to contain the food product. By one approach, the tray may include a first cavity, a second cavity adjacent the first cavity, a peripheral flange, and a rigid bridge. By one approach, the peripheral flange surrounds the first and second cavities that are joined to form a generally oblong or rectangular tray when viewed from above. Further, in some configurations, the peripheral flange has a pinched middle between the cavities and beveled corners such that the rectangular tray has a rounded hourglass shape.

In some configurations, the rigid bridge is recessed below the peripheral flange and extends between the first and second cavities. In one configuration, a first end of the rigid bridge forms a first concave section and a second end of the rigid bridge forms a second concave section of the tray. To provide a hermetically sealed package, the tray may have a flexible film attached to the peripheral flange. In one embodiment, the flexible film has an upper surface and a lower surface, the lower surface may have a sealant disposed thereon, such that the lower surface of the flexible film is hermetically sealed to the upper flange to seal a food product within the tray.

In some embodiments, the cavities of the packaged food product may include a base and a sloped sidewall. The sloped sidewall extends from the peripheral flange to the base and forms at least a portion of the cavity. In use, this sloped sidewall may permit relatively easy removal of the product within the cavity, as discussed below. In some embodiments, the cavities of the packaged food product are reinforced with ribbing. In one illustrative approach, the rigid bridge that extends between the first and second cavities extends from a first lengthwise side of the peripheral flange to a second lengthwise side of the peripheral flange.

In some configurations, the first concave section of the formed tray may be integrally connected to a first lengthwise side of the peripheral flange and the second concave section is integrally connected to a second lengthwise side of the peripheral flange. By some approaches, the radius of curvature of the first concave section and the second concave section is between about 2 and about 5. In one illustrative approach, the radius of curvature is between about 3 to about 4.

In some embodiments, the upper surface of the peripheral flange of the formed tray may be linear to permit the flexible film to be sealed thereto without openings. In one example, the formed tray can undergo baking or other heat-treatment methods with limited warpage to the linear upper surface of the flange. Warpage of the flange can create a discontinuous surface to which the film needs to attach. A discontinuous flange surface may create channels once a film has been attached to the flange, preventing an hermetic seal.

In some embodiments, the packaged food product may include a variety of foods, such as, for example, an egg product disposed inside the cavities of the formed tray. The egg-based product may be, for example, an omelet, egg patty, quiche, frittata, strata, skillet, or scrambled egg. In another aspect, the packaged food product may include another breakfast-type food, such as potatoes in the form of mashed potatoes, hash browns, diced potatoes, or patty. A variety of types of potatoes might be used. For example, suitable potatoes include russet, red, fingerling, LaRette, Yukon Gold, white, sweet, and combinations thereof. In another approach, the packaged food product might include a combination of egg and potato, such as potato croquettes or latkes. In other approaches, the tray may include a first cavity containing a first food product, such as an egg-based product, and a second cavity containing a second food product, such as a potato-based product.

The egg-based product can be prepared from various raw egg ingredients according to the methods described herein. For example, the egg mixture may be prepared from one or more egg products, including one or more of egg white, whole egg, and egg yolk. The egg product may be in liquid or powder form. The egg product may be salted or unsalted. Enzyme-modified egg products, such as protease-treated egg yolk, phospholipase-treated egg yolk, or a combination thereof, might also be used. Further, citric acid-treated egg may be used. In one approach, dehydrated egg products can be rehydrated with an aqueous solution. In another approach, a frozen egg product can be thawed and used, if desired. Generally, it may be beneficial to treat dehydrated egg products to provide a liquid egg mixture, such as by blending and adding an aqueous solution as needed, prior to inclusion in the process. Suitable liquid egg products for use in the egg mixture include, for instance, those having a moisture content of about 65% to about 92% in another aspect about 70% to about 90%. In another aspect, the egg product may be pasteurized prior to use in the present methods and products but is still referred to as a “raw” egg for present purposes. At least in some approaches, it is preferable that the egg product be pasteurized prior to use in the methods.

In other approaches, egg substitutes may also be used. For example, egg substitutes made with plant-based protein are commercially available in both liquid and powdered forms.

When incorporated into the methods described herein, the egg mixture is in liquid form. In another aspect, the liquid egg mixture is in the form of an emulsion. The liquid egg mixture may further comprise other ingredients. In one aspect, the ingredients of the liquid egg mixture are selected to provide a sufficiently high viscosity to reduce splashing when dispensing into the container cavity. Further, the viscosity should be sufficiently high to evenly suspend any inclusions in the egg batter prior to baking (i.e., to provide a substantially homogeneous mixture). As discussed below, an agitation device may be employed to retain the inclusions in a more suspended configurations before the mixture is deposited into the container. However, once the egg mixture is deposited in the containers, it is undesirable for a large amount of the inclusions in the egg mixture to sink to the bottom of the container. A viscosity of the egg mixture that allows no more than 40%, in another aspect no more than 25%, in another aspect no more than 20%, and in another aspect no more than 15% of the inclusions to sink to the bottom of the container during storage at 40° F. for at least 1 hour prior to baking is generally desirable.

In one embodiment, the liquid egg mixture (prior to adding inclusions) has a viscosity of about 5 seconds to about 30 seconds as measured using a Thomas Stainless Steel Zahn Signature Viscosity Cup, #4 size (136 to 899 poise), at a temperature of about 40° F. and immediately after mixing the egg mixture ingredients. In this approach, the Zahn cup is dipped into the liquid egg mixture. After lifting the Zahn cup from the batter, the efflux time of the liquid from a hole in the bottom of the Zahn cup is measured. The viscosity is provided in efflux time (in seconds). In some embodiments, the liquid egg mixture has a viscosity of about 5 to about 25 seconds, in another aspect about 7 to about 25 seconds, and in another aspect about 10 to about 25 seconds.

In one approach, to create an egg mixture with suitable viscosity, it has been found to be advantageous to include one or more of a fat source, a protein source, and starch. Water is added as needed to achieve the desired viscosity and hydration of the starch.

In one approach, two or more of a fat source, a protein source, and starch are included. In yet another approach, each of a fat source, a protein source, and starch are included. Water may also be added as needed to provide a desired viscosity and/or total solids content.

In one aspect, a fat source is included in the egg mixture. The fat source may advantageously contribute to one or more of the viscosity, texture, and flavor of the mixture. For example, the fat source may include one or more of butter, concentrated milk fat, anhydrous milk fat, sour cream, yogurt, an oil with a saturated fat content (e.g., coconut oil, palm oil, palm kernel oil), soft cheese, or other dairy products. For example, suitable soft cheeses include cream cheese, cottage cheese. Neufchatel, Camembert, brie, ricotta, Mexican crema, and mascarpone. At least in some approaches, it is preferred that the fat source comprises a soft cheese. When the fat source includes a soft cheese, it may be desirable to separately blend the soft cheese with the protein source and water to prepare a homogenous mixture (i.e., without cheese clumps) prior to mixing the soft cheese mixture with the egg ingredient and starch. The fat source may be included in an amount up to about 20%, in another aspect about 5% to about 20%, based on the total weight of the liquid egg mixture.

In another aspect, starch is included in an amount effective to increase the viscosity of the liquid egg mixture. For example, the starch may be selected from one or more of instant (pregelatinized) starch, cook up starch, modified starch, and native starch. In one particular approach, the starch is a cold water swelling (CWS) starch and is able to build viscosity in the liquid egg mixture at refrigerated temperatures (e.g., at about 40° F.). In one aspect, the starch may be a modified waxy maize starch, such as Novation Prima 350 (Ingredion). The starch may be included in an amount of up to about 7%, in another aspect about 1% to about 7% starch, based on the total weight of the liquid egg mixture.

In another aspect, a protein source may be included in the liquid egg mixture. In one approach, the protein source may be included to further thicken the egg mixture. For example, the protein source may be selected from whey protein isolate, condensed milk, casein, powdered milk, non-fat dry milk, skim milk powder, condensed milk, ultrafiltered milk, skim milk, and plant-based milk (such as almond, peanut, coconut, cashew, oat, pea protein, and soy-based milks). The protein source may be in liquid or powdered form. In one aspect, the protein source is included in the liquid egg mixture in an amount of up to about 5%, in another aspect up to about 3%, in another aspect about 0.2% to about 3%, in another aspect about 0.5% to about 2%, and in another aspect about 0.5% to about 1.5%, based on a dry weight of the protein source.

In one approach, the liquid egg mixture comprises about 65 to about 90% liquid egg product, up to about 20% fat source, up to about 5% protein source (by dry weight of the protein source), and up to about 7% starch. In another aspect, the liquid egg mixture comprises about 65% to about 75% liquid egg, about 0.5% to about 1.5% protein source (by dry weight of the protein source), about 5% to about 20% fat source, about 1% to about 7% starch, and water. In yet another aspect, the liquid egg mixture further comprises one or more of up to about 1% salt and nisin ingredient in an amount effective to improve microbial stability of the product.

In one particular approach, the liquid egg mixture comprises about 65% to about 75% liquid egg, about 0.5% to about 1.5% non-fat dry milk powder, about 5% to about 20% soft cheese, about 1% to about 7% instant starch, and water by weight of the liquid egg mixture. In another aspect, the liquid egg mixture further comprises one or more of up to about 1% salt and up to about 250 ppm nisin ingredient. In another aspect, the salt is included in an amount of about 0.1% to about 0.4%.

The egg batter may further comprise one or more antimicrobial agents. In one particular aspect, the antimicrobial agent is a natural antimicrobial. The natural antimicrobial can be produced by fermentation using an antimicrobial-producing strain of lactic acid bacteria. As used herein, the term “lactic acid bacteria” generally refers to gram-positive bacteria that generate lactic acid as a major metabolite of carbohydrate fermentation. The lactic acid bacteria may be, for example, an antibacterial-producing strain of Lactococcus lactis or, in alternative approaches, Brevibacterium linens.

In some aspects, the natural antimicrobial comprises a nisin ingredient and, in some approaches, the nisin ingredient comprises nisin “A”, in particular. Nisin ingredient can be obtained by culturing nisin-producing bacteria on natural substrates, including milk. Nisin ingredient has been included in food products to extend the safe, usable life by suppressing gram-positive spoilage and pathogenic bacteria. Due to its highly selective activity, it may also be employed as a selective agent in microbiological media for the isolation of gram-negative bacteria, yeast and molds. A commercially available nisin ingredient is Nisaplin® (Danisco A/S, Denmark). In one particular approach, a nisin ingredient is included in the egg batter in an amount effective to provide no more 250 ppm nisin ingredient based on the final food product when meat inclusions are added, or in another aspect, no more than 600 ppm nisin ingredient based on the final product when meat inclusions are not included.

The food product also may include, for example, seasonings and or other additives to provide different flavor profiles, such as diced vegetables and/or fruit, meats. cheese, and/or other inclusions. As discussed further below, the process for preparing a food product packaged in a formed tray may further include adding at least one inclusion to the food product. In some embodiments, the inclusion comprises one or more of a meat, a cheese, a vegetable, and a fruit.

In another illustrative embodiment, a formed tray for baking a transporting a food product may be described as including a linear flange, a first cavity, a second cavity adjacent the first cavity, a rigid bridge, and a flexible film. The linear flange may be linear to permit sealing the flexible film thereto after baking. The first cavity includes a first base and a first sloped sidewall. The first sloped sidewall extends from the linear flange to the first base and forms at least a portion of the first cavity. The second cavity includes a second base and a second sloped sidewall. The second sloped sidewall extends from the linear flange to the second base and forms at least a portion of the second cavity. The rigid bridge is recessed below the linear flange and extends between the first cavity and the second cavity. A first end of the rigid bridge forms a first concave section, and a second end of the rigid bridge forms a second concave section.

In some embodiments, the rigid bridge of the formed tray may be reinforced with ribbing. In addition to having ribbing disposed on the rigid bridge, the tray also may have ribbing incorporated in other portions thereof, such as, for example, along the lengthwise side of the tray.

In some embodiments, the formed tray for baking and transporting a food product may further include a flexible film. The flexible film may include an upper surface and a lower surface, the lower surface having a sealant disposed thereon. The lower surface of the flexible film may be hermetically sealed to the linear flange of the formed tray to seal a food product within the tray after baking.

In one illustrative embodiment, a process for preparing a packaged food product includes blending a raw egg mixture; applying a coating of oil to the at least one cavity of the formed tray; depositing a blended, raw egg mixture into the at least one cavity of the formed tray; thereafter, heat treating the blended, raw egg mixture in the formed tray; thereafter, transferring the heat-treated egg mixture in the formed tray to a clean room or other sterile area for holding; thereafter, cooling the heat-treated egg mixture; and thereafter, hermetically sealing the cooled, heat-treated egg mixture in the formed tray under vacuum with a nitrogen atmosphere. Such a packaged food product may be easily transported to and reheated by consumers for consumption thereof. In some embodiments, an egg product may be baked in a formed tray and sealed within the same formed tray for storage and transport. The process of baking and sealing an egg product in the formed tray, as described in further detail below, eliminates the need for transfer of the baked egg product to a separate tray for storage and transportation. Thus, baking and sealing an egg product in the formed tray using the process described herein minimizes post-bake contamination and handling.

In some embodiments, the formed tray is a thermoformed plastic tray, which may be formed of, for example, a PET material. By one approach, the PET material may be a fully or partially a crystallized polyethylene tereplithalate tray (CPET).

In some embodiments, the steps of cooling the heat-treated egg mixture and hermetically sealing the cooled, heat-treated egg mixture are completed within the clean room. By one approach, the cooling operation includes cooling the heat-treated egg mixture in a spiral cooler.

In operation, the clean room may have positive air pressure and an air filtration system, wherein the positive air pressure and air filtration system are effective to prevent the formation of condensation on the formed tray. This also may assist with decreasing the risk of contamination after the heat treatment step.

As noted above, the formed tray may include two cavities surrounded by a peripheral flange, with a rigid bridge extending between the cavities that may be recessed below the peripheral flange. The peripheral flange may be generally rectangular in shape with two lengthwise sides and two end sections. In addition, the peripheral flange may include beveled corners. In operation, the beveled corners help to minimize the surface area of the peripheral flange; in particular, beveled corners minimize areas of the flange that are susceptible to warpage when exposed to heat treatment. As suggested above, the lengthwise sides of the peripheral flange may also include a pinched or concave section. An increased radius of curvature of these concave sections helps to reduce the stress on a seal which may later be affixed to the peripheral flange after baking. Furthermore, the rigid bridge of the formed tray may be reinforced with ribbing to provide additional rigidity and structural support between compartments. The formed tray, as further described below, is designed to undergo baking or other heat-treatment methods with minimal warpage and deformation. Because the formed tray described herein maintains structural integrity when baked, a flexible film lidding may be sealed to the peripheral flange of a baked formed tray to produce a hermetic seal without channel leakers.

In some embodiments, the packaged food product comprises a formed tray with a pre-cooked egg product sealed within the cavities of the formed tray using a flexible film. The pre-cooked egg product may be, for example, an omelet, egg patty, quiche, scrambled egg, or other egg-based entrée. To improve the integrity of the seal between the flexible film and the formed tray, a sealant may be disposed on a lower side of the flexible film. A flexible film and/or sealant that are compatible with the formed tray material may also help to further improve the seal integrity.

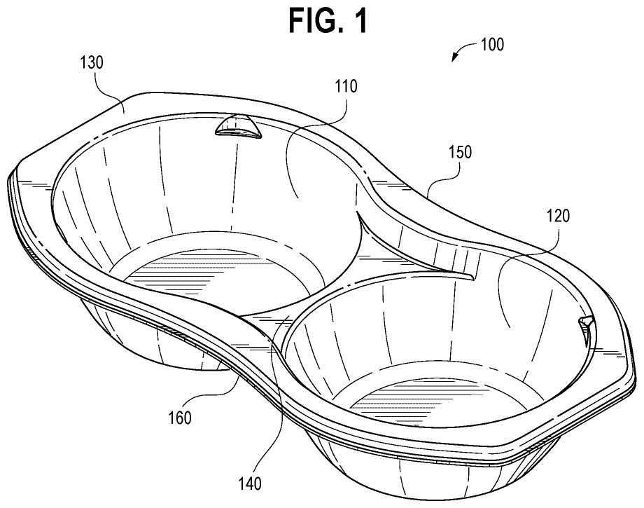

Turning now to the figures, an exemplary formed tray for baking and transporting a food product is illustrated in FIGS. 1-6. FIG. 1 illustrates a two-cavity embodiment of the formed tray 100. In addition to the two-cavity embodiment shown herein, additional cavities may be included. For example, in some approaches, formed trays may include, four cavities, six cavities, or eight cavities. In addition, some of the trays may have a manner to separate one or more cavities from others, such as, for example, a line of weakness, score, or set of perforations in the formed tray and the film atop thereof.

As illustrated in FIG. 1, the formed tray 100 includes a peripheral flange 130, a first cavity 110, a second cavity 120, and a rigid bridge 140. The peripheral flange 130 surrounds the two cavities 110, 120 of the formed tray 100 and includes beveled comers. The peripheral flange 130 is generally a flat surface to which a film may be sealed, secured, adhered, or otherwise attached to hermetically seal a food product in the cavities. Alternatively, in another configuration, the rigid bridge 140 may not be lowered relative to the flange 130 such that the flange 130 to which the film attaches extends between the cavities of the formed tray. Generally, both cavities 110, 120 are recessed below the peripheral flange 130 and the first cavity 110 is positioned adjacent to the second cavity 120. The rigid bridge extends between the first cavity 110 and the second cavity 120.

Further, the rigid bridge of the tray 140, illustrated in FIGS. 1-6, which extends between the first cavity 110 and the second cavity 120, is recessed below the peripheral flange 130. By one approach, the rigid bridge may be recessed about 0.1- to about 0.4-inches, about 0.2- to about 0.3-inches, or more specifically about 0.28-inches below the peripheral flange 130. A first end of the rigid bridge typically forms a first concave section 150 of the tray and a second end of the rigid bridge typically forms a second concave 160 section of the tray. The first concave section 150 and second concave section 160 create a pinched in section between the two cavities, giving the tray an hourglass shape. The radius of curvature of the first concave section 150 and second concave section 160 may be about 2 to about 5, about 3 to about 4, or more specifically about 3.5. Increasing the radius of curvature of the first and second concave sections decreases the curvature on the lengthwise sides and may help to reduce the burden on a seal affixed to the upper surface of the tray.

The rigid bridge 140 may further include ribbing to reinforce the rigid bridge and improve the structural integrity between the first and second cavities. Reinforcing the rigid bridge with ribbing helps to prevent warpage and deformation of the tray during baking or other forms of heat-treatment.

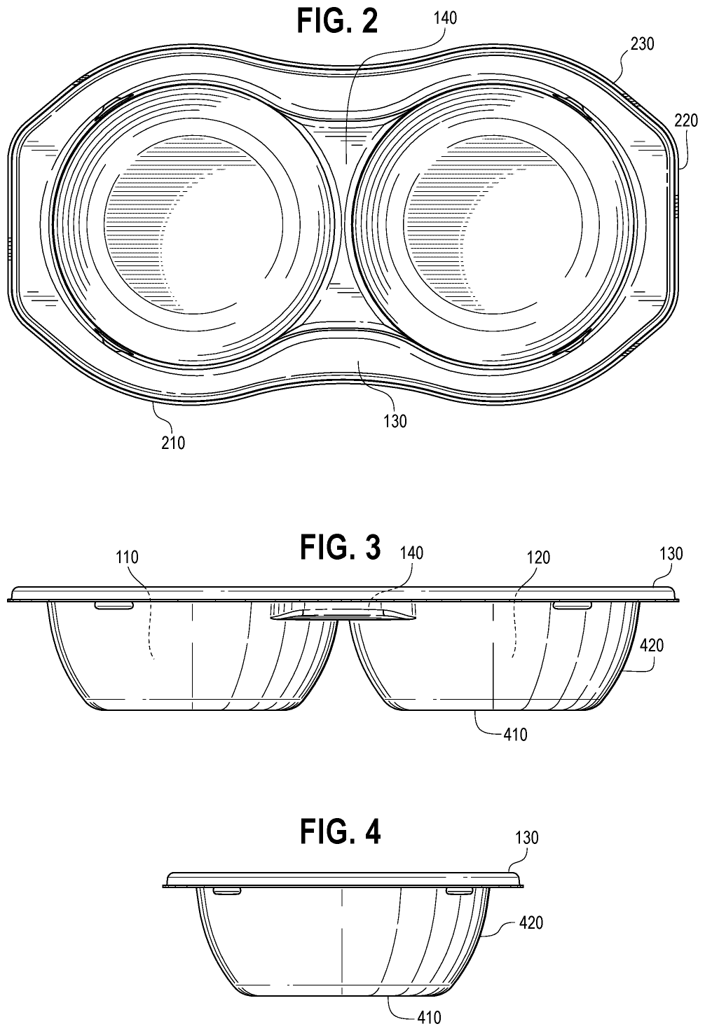

In some embodiments, the peripheral flange 130 defines an upper surface of the formed tray and surrounds the outer periphery of the tray. In some configurations, the peripheral flange 130 is sufficiently flat to permit a film to be sealed or otherwise attached thereto after baking. By one approach, as illustrated with reference to FIG. 2, the peripheral flange may be generally rectangular in shape, including two lengthwise sides 210 and two end sections 220, with a pinched or narrowed portion between the two cavities. By one approach, the lengthwise sides 210 of the peripheral flange may be about 4-inches to about 10-inches, about 6-inches to about 8-inches, or more specifically about 6.78-inches. The two ends 220 of the peripheral flange may have a width between about 2-inches and about 4-inches. The peripheral flange 130 may further include beveled corners 230, which reduces the exposed surface area of the flange and may help prevent the corners of the tray from warping upwards when the tray is baked or exposed to other heat-treatments.

As noted above, the flange 130 to which the film described below is attached has beveled corners 230. In this manner the surface area of the flange 130 is reduced, which helps prevent the material forming the flange from warping or otherwise deforming, such that the flange 130 retains a generally flat or linear surface to which the film can be readily attached. As can be seen from FIG. 2, the flange 130, which not having a uniform width, has a width that remains relatively similar around the cavities.

As illustrated in FIG. 3, the cavities 110, 120 of the formed tray are recessed below the peripheral flange 130. The formed tray includes a first cavity 110 and a second cavity 120 of roughly equal sizes. The first cavity 110 is positioned adjacent to the second cavity 120. In one approach, the first and the second cavities may have a diameter of about 2-inches to about 4-inches, about 2.5-inches to about 3.5-inches, or more specifically of about 3.06-inches. Additionally, the first and second cavities may have a depth of about 0.25-inch to about 2.5-inches, about-0.5 inch to about-1.5 inches, or more specifically of about-1.25 inches, as measured by the distance from the upper surface of the peripheral flange to the base of the cavity. By some approaches, the volume of each cavity may be about 2 fluid ounces to about 6 fluid ounces, about 3 fluid ounces to about 5 fluid ounces, or more specifically about 3.85 fluid ounces.

As illustrated in FIGS. 3 and 4, each cavity may further include a base portion 410 and sloped-sidewall 420 extending inwardly from the peripheral flange 130 to the base 410. While the base portion 410 of the first and the second cavity may be planar, forming a bottom surface of the tray in some configurations, in other configurations, the base portion may be arcuate or textured to assist with removal of the food product from within the cavity. The sloped-sidewall 420 forms at least a portion of the cavity and may be straight or curved. A curved sloped-sidewall 420 creates a dome-shaped cavity which may assist with the removal of a food product from the cavity. Specifically, a dome-shaped cavity allows a consumer to push on one side of the product stored within the cavity thereby creating upward movement on another, opposite side of the food product, which may operate to slide the product out of the cavity using only manual force, without the assistance of utensils.

The formed tray 100 may be formed of various materials such as high-density polyethylene, low-density polyethylene, polyester, polypropylene, polyethylene terephthalate, glycol-modified polyethylene terephthalate, recycled polyethylene terephthalate, polyvinylidene chloride, or polystyrene. In one exemplary embodiment, the tray is formed from a plastic, such as, for example, a crystallized polyethylene terephthalate (CPET) material. The plastic trays, formed as described with reference to FIGS. 1-5, may undergo baking or other-heat treatments without major warpage or deformation and, therefore, may later be hermetically sealed with a flexible film to preserve the tray contents.

By some approaches, the tray may be formed from a material sheet that is about 0.01-inch to about 0.05-inch thick, about 0.02-inch to about 0.03-inch thick, or more specifically about 0.026-inch thick. In some examples, the tray may be a thermoformed or blown tray. In other examples the tray may be injection-molded.

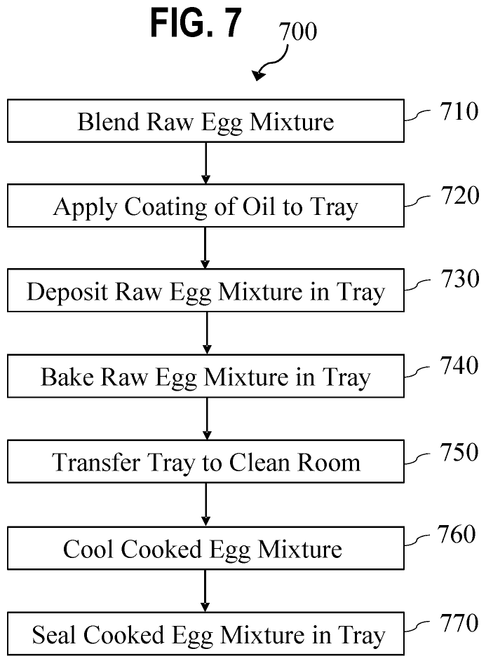

The formed tray shown in FIGS. 1-5 can be baked or otherwise heat-treated in a packaging process, such as the process described with reference to FIG. 7. In some embodiments, the tray may be filled with un-cooked food ingredients then baked to produce a cooked food product. After baking and cooling, a flexible film layer may be adhered to the peripheral flange of the tray to seal the cooked food product within the cavities of the tray. When baked, the tray experiences minimal warpage or deformation. Because there is minimal warpage or deformation of the formed tray, the formed tray exhibits improved seal integrity when sealed with a flexible film.

FIG. 6 illustrates a packaged food product 600. More specifically, FIG. 6 illustrates a formed tray 100 containing an egg-product baked therein and subsequently sealed within the formed tray by a flexible film sealed to the flange thereof.

With reference to FIG. 6, in some embodiments the packaged food product includes a formed tray 100 for baking and transporting a food product, a flexible film 630, and a baked egg product 610, 620. The baked egg product 610, 620 is disposed within the cavities of the formed tray. The flexible film 630 is disposed on the upper surface of the formed tray 100. More specifically, the flexible film 630 is sealed to the peripheral flange of the formed tray 100 to seal the baked egg product in the formed tray for storage and/or transport. In one illustrative approach, the food products 610, 620 are baked and cooled within the formed tray 100 before being sealed within the formed tray 100 before being shipped to consumers, who may then reheat the food products 610, 620 in the formed tray before consumption of the food products 610, 620.

The flexible film 630 of the packaged food product provides a barrier to protect the quality and integrity of the food product disposed in the formed tray. The flexible film may be one or a combination of polymer materials. For example, the flexible film may include polyester, polyvinyl alcohol, ethylene vinyl alcohol, polyvinylidene chloride, polypropylene, polyethylene, and/or nylon. The flexible film may be a single layer or multilayer film. To improve the seal integrity of the final packaged product, the flexible film may be formed from a material that is compatible with the tray material. A flexible film material that is compatible with the composition of the formed tray will help to bond the flexible film to the formed tray in order to effectively seal the flexible film to the formed tray.

The flexible film 630 includes an upper surface and a lower surface. The lower surface of the flexible film may be sealable to the peripheral flange of the tray, optionally in a hermetic manner. In some examples, the flexible film may further include a heat seal coating sealant layer, a cold seal adhesive, or a pressure sensitive adhesive. For example, a pressure sensitive adhesive may be disposed on the lower surface of the flexible film in order to seal the flexible film to the peripheral flange of a tray. In one example, a cold seal adhesive may be disposed on the lower surface of the flexible film and on the peripheral flange of the formed tray to bond the flexible film to the formed tray. In another example, the lower surface of the flexible film may include a heat and pressure-activated sealant that attaches to the peripheral flange of a tray via heat and pressure. In some embodiments, the flexible film may be sealed to the formed tray under vacuum with a nitrogen atmosphere.

In some embodiments the flexible film is peelable to create a final product with an easy-open package seal. In addition to initially baking the food product in the formed tray, in some configurations, the food product also may be reheated within the tray. Accordingly, in such configurations, the tray is microwavable, such that, the food product may be reheated in a microwave oven while disposed within the cavities of the tray. In addition, the flexible film attached to the tray also may be microwaveable so that, the entire packaged product may be re-heated in a microwave oven.

In one example, the flexible film may be clear so that the contents of the tray are visible after the flexible film has been sealed to the tray. In other examples, the film may be matte, colored, or white. By some approaches, the film may also be printable by methods, such as, offset or screen-printing, allowing the flexible film to incorporate graphics. For example, the flexible film may include ingredient lists, nutritional information, and/or instructions for storing, preparing, or re-heating the food product.

The food product 610, 620 sealed within the formed tray may be an egg product. The egg product may comprise whole eggs, egg whites, and/or egg yolks. The raw egg product may also include a reconstituted dried egg mix. More specifically, the food product may, for example, be an omelet, egg patty, quiche, scrambled egg, or other egg based entrée.

The egg product 610, 620 may further comprise one or more flavorings, spices, food safety ingredients (e.g., an antimicrobial agent), and/or inclusions. By one approach, the inclusions may comprise, for example, one or more of a meat, cheese, vegetables, fruit, and/or other flavors. The meats may comprise one or more of ham (such as Applewood smoked ham or other flavored ham), bacon, Canadian bacon, sausage (such as pork, turkey, or chorizo), and/or other meats. The meat may be cured or uncured. Depending on the meat, the meat may be shredded, crumbled, diced or otherwise reduced to suitable pieces. The cheese may comprise one or more of extra sharp cheddar, sharp cheddar, mild cheddar, American, Swiss, mozzarella, pepper jack, provolone, and/or other varieties of cheese. The vegetable may comprise one or in more of red pepper, green pepper, mushroom, onion, potato, jalapeno, garlic, tomato, spinach, and/or other vegetables.

Once sealed, the packaging prevents contamination and protects the food product during storage and/or transportation. By one approach, the food product may require refrigeration during storage and transportation until the food product is ready to be unpackaged and consumed. In some approaches, the packaged food product may be microwaved by a consumer to reheat the food product prior to consumption.

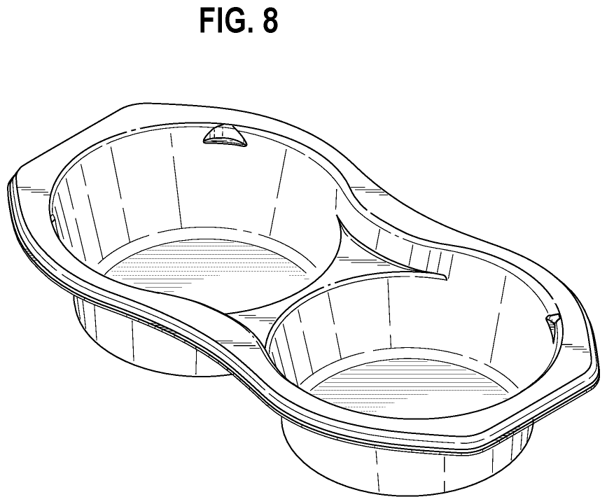

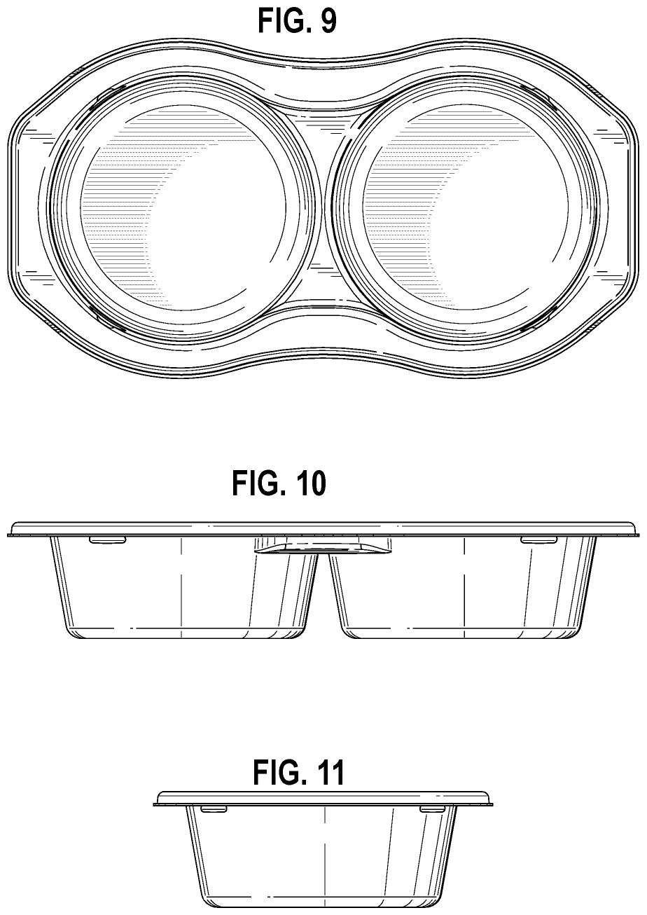

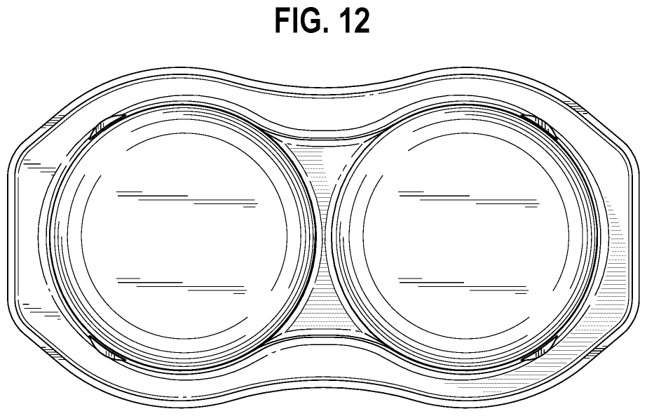

FIGS. 8-12 illustrate an additional embodiment of a formed tray for baking and transporting a food product. Specifically, FIGS. 8-12 illustrate a two-cavity embodiment of the formed tray including cavities with straight sidewalls.

The packaging materials described above may be used in a variety of manners. In some embodiments, a food product is prepared in the formed tray described herein. More specifically, a food product is baked in the formed tray and subsequently sealed in the same formed tray to produce a packaged food product that may be stored and/or transported.

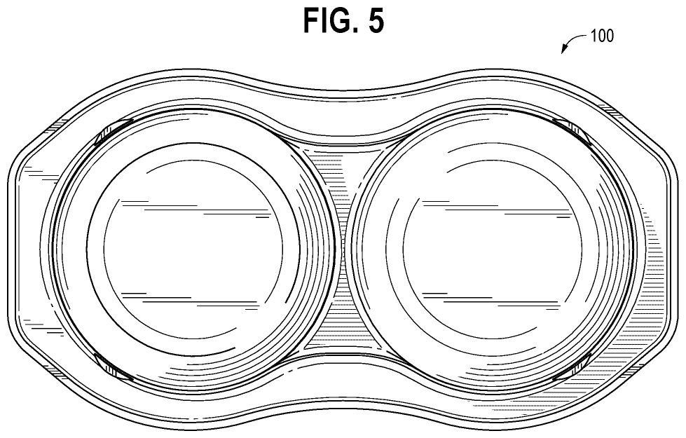

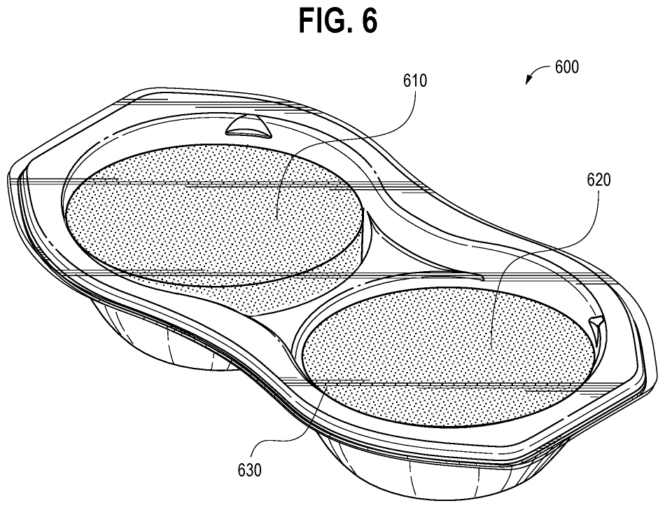

In one illustrated embodiment, a food product is baked and sealed in the same formed tray according to the process of FIG. 7. Baking a food product in the formed tray illustrated in FIGS. 5 results in minimal tray warpage or deformation, a decrease in the contamination risk associated with food transfer, and a minimal amount of waste given that the tray may be used for a number of different processes. In this manner, the baked food product does not need to be transferred to a separate tray for sealing and transport. Indeed, as suggested above, transferring a baked food product from a baking tray to a separate packaging tray can introduce pathogens, yeast, and/or mold into the baked food product. Therefore, baking and subsequently sealing the baked food product in a single tray reduces the risk of post-bake contamination.

FIG. 7 illustrates an exemplary process 700 for preparing a baked egg product in the formed tray. In the process of FIG. 7, after baking, the egg product is sealed in the formed tray for transportation and/or storage.

At step 710, a raw egg mixture is blended. The raw egg mixture may include whole eggs, egg whites, egg yolks, and/or mixtures thereof. The raw egg mixture may also include a reconstituted dried egg mix. In some embodiments, seasonings, food safety ingredients, and/or inclusions may also be incorporated into the blended raw egg mixture. Inclusions may comprise, for example, one or more meats, vegetables, and/or cheeses.

At step 720, a coating of oil is applied to each cavity of the formed tray. In one example, the coating of oil may be applied to the base of the cavity. In another example the coating may be applied to both the base and the sidewall (or a portion thereof) of the cavities. This coating of oil prevents the egg mixture, or other food product, from sticking to the cavity and allows the baked-egg mixture to be easily removed from the cavity after baking.

To improve seal integrity on the final packaged product, care may be taken to avoid depositing oil or other materials (such as food product, water, and/or particulate, among others) to the peripheral flange of the formed tray. Indeed, the presence of oil on the peripheral flange may prevent the flexible film from sufficiently bonding to the flange and, as a result, may contribute to channel leakers, or conduits for the passage of air and/or contaminants, between the flange and the flexible film. In some embodiments, the coating of oil may be sprayed, brushed, blotted, or otherwise directed onto the formed tray. In one illustrative example, the coating of oil may be applied to the cavity of the formed tray with a directed nozzle.

After coating portions of the formed tray with oil, at step 730, the blended raw egg mixture is deposited into the cavities of the formed tray. To improve seal integrity on the final packaged product, care may also be taken to avoid depositing the raw egg mixture on the peripheral flange of the formed tray. The presence of egg mixture on the peripheral flange also may inhibit the formation of a sufficient bond or seal between the flexible film and the flange of the tray and, as a result, may contribute to channel leakers between the flange and the flexible film.

At step 740, the blended, raw egg mixture is heat treated or cooked in the formed tray. In some embodiments, the raw egg mixture is cooked by baking the raw egg mixture in the formed tray in a production oven. In some embodiments, the raw egg mixture in the tray may be exposed other forms of heat treatment in order to cook the raw egg mixture. Other forms of heat-treatment may include, for example, immersion in boiling or hot water or exposure to steam. By some approaches, the eggs may be cooked until the eggs coagulate. For example, the egg mixture may be cooked to an internal temperature of about 165° F. to kill any bacteria that may be present in the eggs or to at least 185° F. to coagulate and set the egg proteins to provide a fully cooked egg product.

At step 750, the baked (or otherwise heat-treated) egg mixture, while still in the formed tray, is transferred to a sterile or clean room. The clean room may be, for example, a contained space with a controlled environment to reduce contaminants such as dust, airborne microbes, aerosol particles, and/or chemical vapors, among other potential contaminants. In some embodiments, the clean room may have a positive air pressure. The clean room may include an air filtration system equipped with an air filter such as a high efficiency particulate air (HEPA) or ultra-low particulate air (ULPA) filter. Conditions in the clean room may be designed to prevent the formation of condensation on the egg mixture or on the formed tray. Condensation on the egg mixture and/or formed tray can result in microbial growth and lead to contamination of the cooked egg mixture. it is therefore desirable to minimize condensation after baking.

At step 760, while still in the formed tray, the baked egg mixture is typically cooled by placing the formed tray in a suitable cooler. In some embodiments, the cooler is located within the clean room. The cooler may be, for example, a spiral cooler or other conventional cooling equipment. Cooling the baked egg mixture and formed tray prior to sealing also contributes to improved seal integrity of the final package. When a seal is applied to a hot tray under vacuum, moisture typically accumulates between the flexible film and the peripheral flange. The presence of moisture in the seal area reduces seal integrity and results in channel leakers.

At step 770, the cooled, baked egg mixture is sealed in the formed tray. In one embodiment, to seal the baked egg mixture in the formed tray, a flexible film may be bonded to the peripheral flange of the formed tray. In some examples, the flexible film may be hermetically sealed in the formed tray. Sealing may optionally be done under vacuum and the package may be gas flushed. Furthermore, sealing may optionally be done with a modified atmosphere such as a nitrogen atmosphere. Modified atmosphere packaging may provide the packaged food product with increased shelf-life, by providing a packaging environment that slows down the natural deterioration of the food product.

Sealing may be accomplished by heat seal or cold seal. In some approaches, sealing is accomplished by sealing the flexible film to the formed tray via a combination of heat and pressure. In some embodiments, the flexible film may be sealed to the formed tray using a tray sealer or a form fill seal machine. In other embodiments, the flexible film may be sealed to the formed tray by some sort of adhesive of cohesive, such as, for example, a cold seal adhesive using a cold seal packaging machine.

In some embodiments, the cooled, baked egg mixture is sealed in the formed tray within the clean room. Sealing the baked egg mixture within the clean room may help prevent any post-bake contamination.

A final packaged baked egg product that has been prepared according to the process of FIG. 7 may be stored at refrigerated or frozen temperatures until use. The packaged baked egg product may be microwaved by a consumer prior to use to re-heat the product. In one embodiment, the final packaged food product described herein has a refrigerated shelf life of at least about 90 days, in another aspect about 100 days, in another aspect at least about 110 days, and in yet another aspect at least about 120 days. Indeed, in some configurations, the refrigerated shelf life is between about 90 to about 120 days.

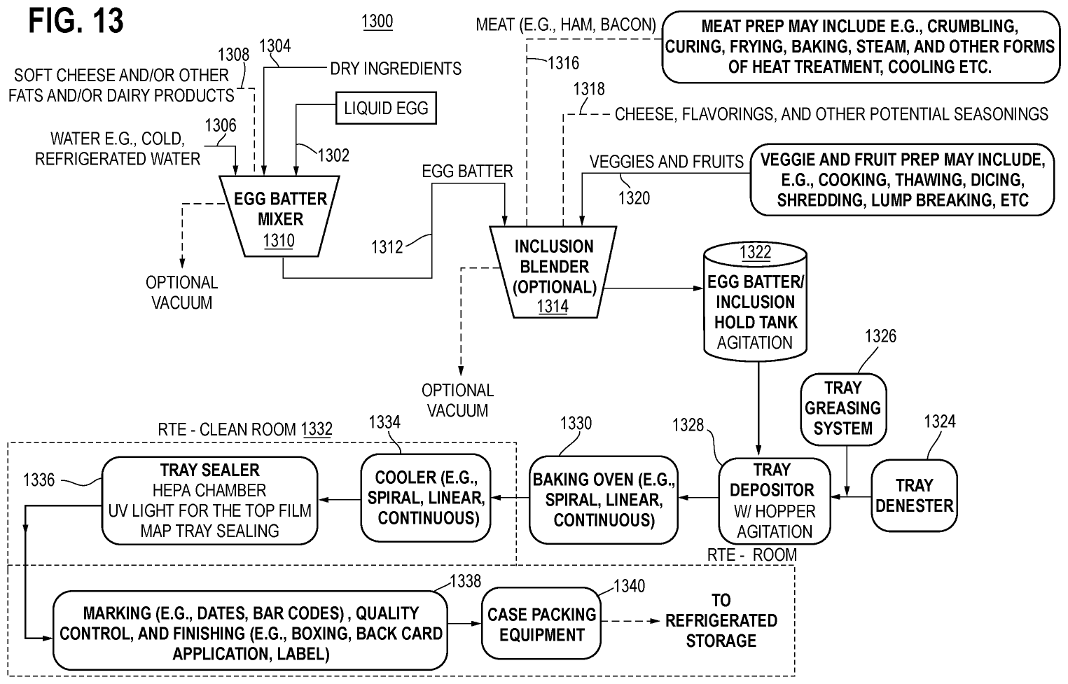

Turning now to FIG. 13, a system 1300 is illustrated for manufacturing ready-to-heat or reheat food products, such as, for example, an egg round or omelet, a potato cake, or similar meal component. As used herein, the ready-to-heat food products have undergone initial thermal processing before being shipped, so that the consumer may quickly reheat the product before consumption. For products with eggs therein, the thermal processing step cooks, solidifies, and denatures the proteins in the mixture. A variety of temperatures may be employed for thermal processing and illustrative examples are discussed below. The system 1300 for making a packaged food product, such as product 600 described above, may be leveraged to prepare a formula of batter, prepare a thermoformed tray, dose a mixture or portion of the batter into the thermoformed tray, and thermally process the food product in the tray, before cooling and sealing the product within the tray while in a clean room.

As shown in FIG. 13, the system 1300 includes ingredients streams, such as a liquid egg stream 1302, a dry ingredient stream 1304, and a cold-water stream 1306, which are fed into the egg batter mixer 1310. The egg batter of the liquid egg stream 1302 may be comprised of whole liquid eggs, liquid egg whites, liquid egg yolks, or liquid egg substitutes in a variety of ratios and formulations, as discussed above. In some embodiments, the water added in the ingredient stream 1306 is cold water generally having a temperature between about 32° F. and 50° F. and in some embodiments about 37° F. or 38° F. to about 45° F. In one illustrative process, the water is added at a temperature of just below about 40° F., i.e., 38° F. to 39° F.

In addition, the dry ingredient stream 1304 may include a plurality of streams with, for example, a number of different starches, protein sources (such as powdered non-fat dry milk), antimicrobials, and/or food safety ingredients, among other options. Alternatively, these ingredients may be combined into one stream added to the egg batter mixer 1310. As used herein, the starch assists, for example, with creating a desirable mouthfeel in the final food product, preventing splatter of the mixture as it is deposited into the food tray, helping suspend the inclusions in the egg mixture, and/or assisting, in maintaining the structure of the food product during its shelf-life.

Further, in some illustrative embodiments, an optional ingredient stream 1318 may deliver additional ingredients into the egg batter mixer 1310 including, for example, a soft cheese, such as a Neufchatel, cream cheese, sour cream, cottage, cheese, or other similar fat and/or dairy products. The optional ingredient stream 1308, in some configurations, is added into the egg batter mixer 1310 along with the liquid egg stream 1302, the cold-water stream 1306, and the dry ingredient stream 1304. As discussed above, in one illustrative approach, a soft cheese, such as a Neufchatel is first blended with a rehydrated non-fat dry milk and then added with the other ingredients into the egg batter mixer 1310.

By one approach, the mixers (e.g., blenders 1310), blenders (e.g., inclusion blender 1314), and holding tanks (e.g., egg batter and inclusion holding tank 1322) described herein may include jacketed covers to help retain the temperature of the primarily raw mixed ingredients to below 40° F., and specifically below about 38° F. In some configurations, the egg batter mixer 1310 and the inclusion blender 1314 may be run under vacuum.

As illustrated in FIG. 13, the raw egg batter ingredient stream 1312, is mixed with inclusions, such as, for example, a meat stream 1316, a cheese, flavorings, and other potential seasonings stream 1318, and a vegetable and fruit stream 1320. The inclusions may be prepared in a variety of manners, as mentioned below, including pre-cooking and reducing the size thereof to facilitate mixing with and suspension within the raw egg batter.

More particularly, in some configurations, the inclusion blender 1314 receives the egg batter stream 1312, the meat ingredient stream 1316 (if included), an optional stream of cheese, flavorings, and other potential seasons ingredient stream 1318 (if included), and an optional stream of vegetable and fruit inclusions 1320. As suggested above, the meat ingredient stream 1316 and the vegetable and/or fruit ingredient stream 1320 may be processed in a number of manners in preparation for combination with the egg batter stream 1312. In some configurations, the meat inclusions may be, for example, crumbled, cured, fried, baked, cooled, frozen, dehydrated, rehydrated, diced, chopped, thawed, and steamed, among other forms of heat treatment and manipulation in preparation for combination with the egg mixture. In some embodiments, the optional meat inclusions may include, e.g., ham, bacon, sausage, ground meat, and meat substitutes. In this manner, the meat inclusions may be for example bacon bits or diced ham, which are small enough to be added to the raw egg mixture and be incorporated and suspended therein.

In some configurations, the vegetable and fruit ingredients may be, for example, cooked, dehydrated and/or rehydrated, thawed, diced, shredded, crumbled, chopped, and/or mashed, among other steps. In some embodiments, the vegetables and fruits may include, e.g., tomatoes, onions, broccoli, peas, spinach, potatoes, such as shredded and/or frozen sweet and/or white potatoes like dehydrofrozen shredded potatoes, and bell peppers, among other options. In addition, other inclusions may be incorporated into the final product, such as tofu or other meat substitutes and/or nuts or seeds, like pine seeds, among a myriad of other optional inclusions.

While the exemplary system 1300 of FIG. 13 illustrates the meat, cheese, veggies, and fruits being inclusions in a food product that is primarily egg-based, the systems and processes described herein also may be modified so that the non-egg ingredients form a greater portion of the final food product. For example, the teachings herein can be employed to produce a food product that is comprised primarily of shredded potato or hash brown based with meat such as bacon and eggs used to form the product's shape. While the final product may be similar in size and may be baked and shipped in a similar thermoformed tray, the formula may be adjusted to produce a variety of final food products.

Once the egg batter stream 1312 is combined with the various inclusion streams 1316 1318, 1320 incorporated therein (such as in the optional inclusion blender 1314), a holding tank 1322 may retain the combined formula until the thermoformed trays are ready to receive the batter. In one illustrative embodiment, the inclusions are distributed within the egg batter in a random manner, but generally dispersed therethrough. For example, the egg batter is generally thick enough (in light of the added starch discussed above) to suspend one or more of the inclusions throughout the egg batter so that the inclusions do not fall out or drop entirely to the bottom of the food product, or float to the top. To assist with maintaining a relatively even distribution of the inclusions within the egg batter, the holding tank 1322 may agitate the combined formula in a continuous or discrete process to retain at least some of the inclusions in a suspended configuration in the egg batter.

As mentioned above, the process and the tray are configured to create a seal between the flange thereof and the film that retains the food product therein. Because the batter is cooked within the same tray in which the product is shipped, the process is calibrated to ensure the tray, and in particular the flange, are suitable for being sealed therewith. To that end, the structural integrity of the flange is sufficiently maintained and the flange remains generally free of contaminants that would interfere with a package seal. For example, the flange remains free of oil and batter during the processes described herein. Further, the flange is configured to remain substantially linear or flat even during thermal processing. For example, the tray is configured to reduce warping, the baking process is designed to limit deformation of the tray, and the cooling process is designed to limit build-up of condensation on the flange.

As noted above, the batter (whether it is comprised primarily of liquid eggs or another ingredient, like shredded potatoes), is thermally processed within the trays illustrated herein. To prepare the thermoformed trays to receive the batter, the trays are first denested or separated from one another at a tray denester 1324 (potentially dusted or cleared with a burst or flush of air), then greased or sprayed at a tray greasing system 1326. A variety of denesting equipment may be employed and the thermoformed trays may have lugs (e.g., an alternating pattern of lugs in the trays) incorporated therein to facilitate the process. Once the trays are denested, a grease or oil, such as the oil described above, is applied to the interior of at least a portion of the tray cavities that will receive the batter. Despite the presence of fat within the batter, the sprayed oil assists with evacuation of the cooked food product. In addition to the oil, the cavities of the tray may have a rounded, inverted dome shape to further assist a consumer with removing the food product therein.

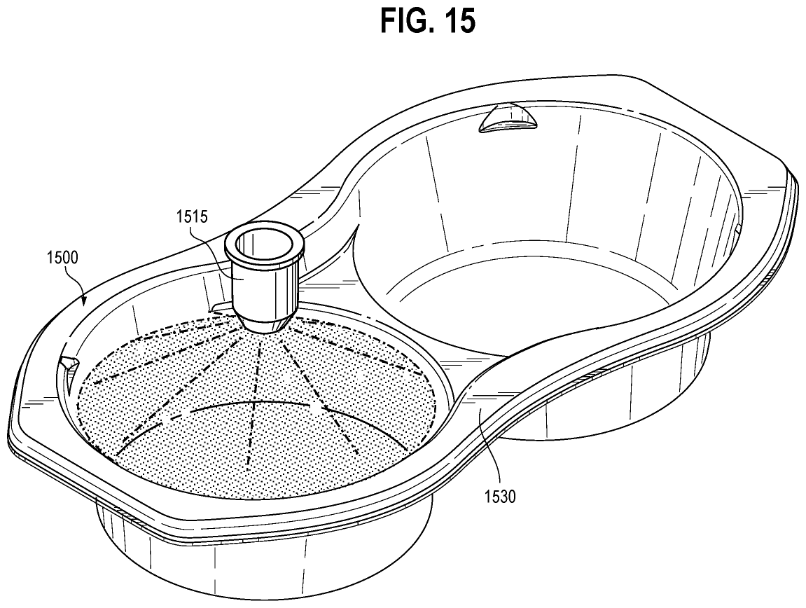

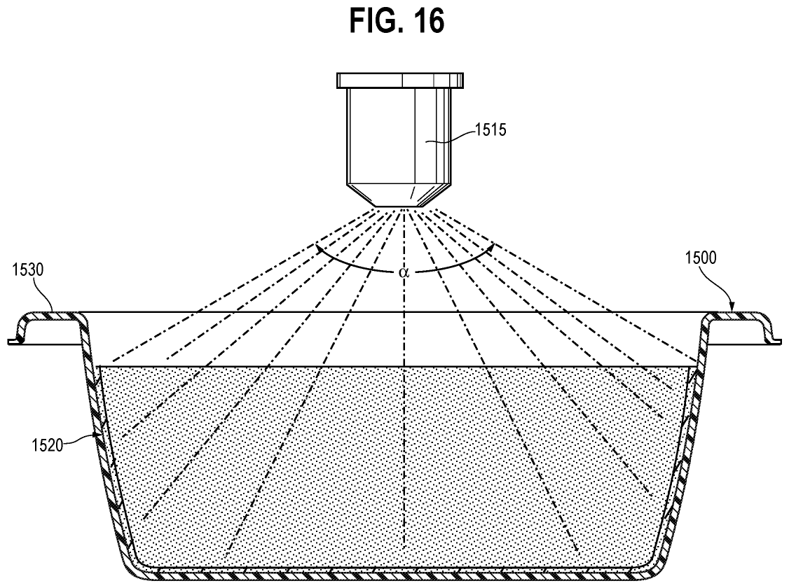

FIGS. 15 and 16 illustrate an exemplary spray nozzle 1515 over an exemplary thermoformed tray 1500. As discussed below, seal integrity between the tray flange and the film is improved by providing a flat, clean flange with which the film can seal. Accordingly, the system 1300 may employ a tray greasing system 1326 designed to avoid or prevent oil or grease from being applied to the flange. In one illustrative approach the nozzle 1515 is disposed between about 0.25-in. to about 0.075-in. above the tray. In one exemplary embodiment, the nozzle 1515 is disposed about 0.5-in. above the flange of the tray. While a standard spray nozzle has a cone or a spray angle of about 30°-80°, one illustrative embodiment includes a spray nozzle with a wider cone and coverage area, such as, for example, a spray nozzle with a cone or angle of about 115°. For example, if the spray nozzle 1515 has a spray angle, α, that is about 115° and is disposed about 0.125-in. to about 0.5-in. above the flange of the tray, the oil that is sprayed from the nozzle is disposed on the base and the walls of the cavities, such that the flange remains free of oil. By having a wider coverage area and a nozzle positioned closer to the base of the tray, it permits a thin, continuous coverage of oil (e.g., an even distribution of oil droplets over a portion of the interior of the tray cavity) to be applied, in a controlled manner, in the area where the food product will be present upon thermal processing. While too little oil renders the food product difficult to evacuate from the tray, too much oil might cause the oil to bubble up onto the flange, which may interfere with the seal, as discussed below. In one illustrative approach, about 1 to about 5 grams of a liquid oil, at refrigeration temperatures, such as a canola oil with an emulsifier are sprayed (at an elevated temperature) into each cavity via the spray nozzle 1515 at a 40-80 psi. Further, the specific amount of oil employed, and the pressure used for application may depend, in part, on the type of egg product being thermally processed. For example, a product with a higher fat content may require less oil that can be applied at a lower psi.

After the trays have been sprayed with the oil at the tray greasing system 1326, the trays advance to the tray depositor station 1328 that fills the oiled trays with the batter or mixture. Similar to the other steps described herein, the depositing station 1328 is designed to ensure that the batter is disposed only within the cavities of the tray and does not splash onto the flange. A variety of baking ovens may be employed, such as, a spiral, linear, and/or continuous oven. In addition, a combination of ovens or heating elements may be employed. Commercially available ovens, such as, for example, a JBT oven or a Mecatherm oven may be employed with the teachings described herein.

In one illustrative embodiment, the baking includes heating the interior of the mixture sufficiently to kill pathogens, denature the proteins, and solidify the mixture, it also may include a browning operation that renders a portion of the top surface browned and slightly toasted. For example, in addition to raising the internal temperature of the product to at least about 185° F. the baking oven also may incorporate a broiling or browning operation. Accordingly, the baking oven system 1330 may include multiple heating elements, such as a convention heating element, a broiler, a radiant heating element, impingement browner, among others. Though the browned, crispy portion of the food product provides a pleasant appearance and mouthfeel, browning a food product is particularly challenging in a thermoformed tray, especially if a flame-based browning equipment is employed. Accordingly, the process is highly calibrated (i.e., the temperatures are retained below a particular threshold for a particular length of time) and, in some configurations, the baking oven system 1330 employs a two-step process that may occur in two different zones. This approach also may help reduce the puffing of the food product, which assists with retaining the integrity of the tray flange. Indeed, the multiple baking steps are configured to prevent puffing of the food product, which can elevate the product to be adjacent to the flange, which can cause portions of the product or the oil to contaminate the flange.

In one illustrative approach, the baking oven system 1330 includes a multi-zone oven, such as a first zone and a second zone with a continuous feed operation through both zones that takes a total of about 15-20 minutes with an ambient air temperature of about 400° F. In some embodiments, the baking oven system 1330 includes a first, second, and third zone. In some exemplary approaches, the product is cooked or baked for about 16 to about 17 minutes.

For example, in some configurations, in a first zone, the heating element on the bottom or underneath the trays is set to about 230° F. to about 250° F. and the upper temperature is set to about 500° F. to about 530° F. such that the ambient air is about 400° F. In this manner, the tray reaches a temperature of about 300° F. to about 330° F. when exiting the first zone. In the second zone, similar baking parameters may be employed. Further, the belt speed in these zones may be, for example, about 1.25 ft/min. to about 1.375 ft./min. In other configurations, the belt speed may be between about 0.8-1.375 ft/min. Though similar or identical temperatures may be employed for the multiple baking zones, different temperatures also may be employed for the different zones, thereby employing a more step-wise baking operation.

The food product in the tray, in one exemplary approach, undergoes a browning operation. In some configurations, the browning operation includes an impingement browner in the baking oven system 1330, which may have one or more modules, with heating elements set around 345° F. and a belt speed of about 0.9-1.0 ft/min. In some embodiments, the impingement browner may have heating elements set between about 380° F. to about 415° F. with a belt speed of between about 0.8-1.0-ft/min. By some approaches, if the heating element is set to a relatively lower temperature, the belt speed is generally set to a slower speed.

In yet another example, the impingement browner may be set to about 250° F. and is relatively close to the top of the tray, e.g., the heating plate may be about 4-6-in. above the food product. In addition, in such a configuration, the food product may be exposed to the impingement browner for about 4 minutes.

In addition, the thermoformed trays may be placed directly on a conveyor belt or within an optional baking pan as it moves through the baking oven system 1330.

To ensure that the baking oven system 1330 was properly calibrated, temperature strips were applied to an exemplary tray and the temperature of a variety of portions of the tray were measured to confirm that the tray was not heated beyond about 410° F. to about 420° F. at the flange, which is the temperature at which warping becomes a significant concern for the thermoformed tray. In addition, the tray is not heated beyond 290F at the areas thereof that interact with the food product such as the sidewalls and the bottom of the cavity.

Limit the potential for contamination of the product, the trays with the baked products are cooled and sealed in a ready-to-eat dean room 1332 with a HEPA filter cleaning the air. Accordingly, the cooling system 1334 and the tray sealer 1336 are disposed within the clean room. In operation, the cooling system 1334 may include multiple and a variety of coolers, such as, a spiral, linear, and/or continuous cooler. As noted above, the cooling process, as described further below, is designed to reduce or eliminate condensation on the flange itself and on portions of the equipment to ensure that the condensation doesn't drop onto the flange or another portion of the tray or product. To that end, by one approach, the cooling system 1334 operates between about 20° F. to about 50° F. at a relative air hygrometry measurement of between about 45% to about 95%. In addition, the cooling system 1334 may operate in a plurality of zones or modules with differing parameters to drive down the temperatures in a stepwise manner and avoid build-up of condensation.

In some illustrative approaches, the cooling system 1334 may receive the food product at a temperature of about 185° F. to about 190° F., with the bake pan (including the thermoformed tray and any surrounding pan retaining the thermoformed tray(s)) at a temperature of just above 300° F. In addition, the exit temperatures from the cooling system 1334 may be about 20° to about 25° F. for the bake pan with a product temperature of about 35° F. to about 42° F. In one illustrative embodiment, the product exits the cooling system 1334 at about 39° F. and the bake pan exits at a temperature of about 23° F. Accordingly, the cooler air temperature (fan) is about 23° F. at the exit. A variety of cooling equipment may be used to cool or reduce the temperature of the product including, for example, a spiral, linear, and/or continuous cooler.

As noted, in some embodiments, the cooling system 1334 may have multiple modules to reduce the temperature in one or more steps. By one approach, the zones have similar dwell times, but in another configuration, the dwell times for the zones may vary. For example, a first zone may be set to an air temperature of about 40° F. to about 46° F. with a relative air hygrometry of between about 46%-52%, with a dew point of between about 23° to about 28° F., a product temperature (upon exit from the first zone) of between about 95° F. to about 105° F. upon exit from the zone, and a moisture or water loss of the food product while processed in the zone of about 0.5% to about 1.5%.

Further, a second zone may be set to an air temperature of about 26° F. to about 32° F. with a relative air hygrometry of between about 76%-82%, with a dew point of between about 22° to about 28° F., a product temperature (upon exit from the second zone) of between about 56° F. to about 62° F. upon exit from the zone, and a moisture or water loss of the food product while processed in the zone of about 0.4% to about 0.6%

In addition, a third zone may be set to an air temperature of about 23° F. to about 27° F. with a relative air hygrometry of between about 93%-96%, with a dew point of between about 22° to about 28° F., a product temperature (upon exit from the third zone) of between about 36° F. to about 41° F. upon exit from the zone, and a moisture or water loss of the food product while processed in the zone of about 0.4% to about 0.6%.

One illustrative set of module parameters is listed below in Table 1.

TABLE 1

| | | Zone | |
|---|---|---|---|
| | Zone | Module | Zone |
| Cooling Parameters | Module 1 | 2 | Module 3 |
| Cooler Air | 44.2° F. | 29.8° F. | 25.2° F. |
| Temperature (Module) | | | |
| Relative Air | 49.3% | 79.4% | 94.5% |
| Hygrometry (Module) | | | |
| Dew Point Temperature | 27.1° F. | 24.9° F. | 24.0° F. |
| Dwell Time | 17.5 mins | 17.5 mins | 17.5 mins |
| Bake Pan Temperature | 54.7° F. | 30.9° F. | 25.2° F. |
| Product Temperature | 100.4° F. | 59.9° F. | 39.2° F. |
| (upon exit) | | | |
| Moisture/Water Loss | 1.3% | 0.5% | 0.5% |

Once the product has cooled, the product is advanced to a tray sealing apparatus 1336 that seals the food product into the tray in a hermetic manner. In one illustrative embodiment, the tray sealing apparatus 1336 includes a UV light that sterilizes the film that is sealed to the flange. For example, the UV film treatment light may include a Heraeus lamp to sterilize the film being applied to the tray. By one approach, the tray sealing apparatus 1336 is a modified atmosphere sealer that helps extend the shelf life of the product by operating under vacuum and/or gas injection or flushing. In addition, the tray sealer may employ a HEPA filter to reduce contaminates and extend shelf life. Once the food product is sealed within the tray, the package may be routed outside of the clean room 1332.

As illustrated, the system 1300 also typically includes a marking, quality control, and finishing system 1338, and case packing equipment 1340. These systems may be disposed outside of the clean room 1332 as the food product is hermetically sealed within the tray at the tray sealer 1336 within the clean room 1332. In addition, these systems may include a labeler, boxing equipment, back card application equipment, among other devices. While previously developed systems formed egg-based food products having a refrigerated shelf life for a month or so, the illustrative process 1400 described below produces food products that retain their freshness for upwards of 90-120 days.

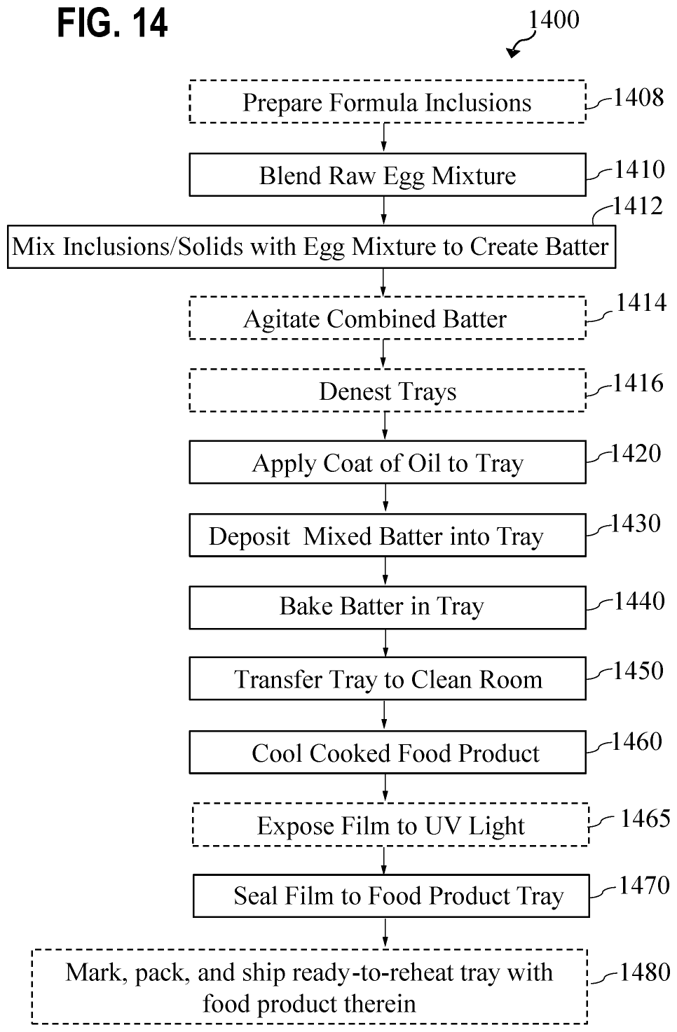

Turning now to FIG. 14, an illustrative process 1400 for making a food product is shown. In step 1408, the formula inclusions are prepared in a variety of manners, which may depend, in part, on the inclusions being incorporated into the food product. For example, the inclusions may be prepared by one or more of baking, curing, frying, steaming and other forms of heat treatment, and chopping, dicing, crumbling, breaking up frozen chunks, and other forms of piece size reduction. If the inclusions are heat treated, such as, for example, by frying and crumbling pork belly into bacon bits, the inclusions are generally cooled and either frozen, chilled, or refrigerated, before they are blended into the mixture.

In step 1410, the raw egg mixture is blended. As discussed above, the egg mixture may include both whole liquid eggs and liquid egg whites. In some configurations only liquid egg whites or a liquid egg substitute may be used. In addition, blending 1410, the raw egg mixture includes both the egg portion of the formula and typically cold water and dry ingredients, such as starch, along with optional cheese, fat, and/or dairy product mentioned above.

In another configuration, the process 1400 may be employed such that the solid vegetables and fruits are the primary component of the food product and the egg mixture is primarily employed as a binder to retain the product shape.

In step 1412, the final food product formula is prepared by combining the inclusions or solids with the egg mixture to create the batter. By one approach, the raw egg mixture is the primary ingredient and it is mixed with the solid inclusions. By another approach, the solid vegetables and/or fruits are the primary ingredient and a smaller portion of liquid raw egg mixture is added thereto. Accordingly, the process 1400 may be used to prepare, e.g., an egg cake, round, patty, or omelet or other items like, e.g., a hash brown, latke or croquette, among many other options.

Once the final food product formula is mixed, the mixture is retained in one or more holding tanks before cooking. While disposed in the holding tanks, the mixture may be agitated 1414 to retain proper dispersion of the various ingredients. In some configurations, the process 1400 also includes denesting 1416 the trays, such as by leveraging the lugs in the tray to orient them in a manner that will be easy to arrange for receipt of the sprayed oil and the food product mixture.

As mentioned above, in one illustrative configuration, the mixed batter has sufficient viscosity to suspend the inclusions therein and not cause the batter to splatter onto the flange when depositing the mixed batter into the tray. To that end, the egg mixture typically includes sufficient starch and is typically below 45° F. during the depositing step described below.

The process 1400 also includes applying 1420 a coat of oil to the tray, such as the oil described above, via the spray nozzle 1515. The application 1420 of the oil is concentrated on the base of the cavities and the lower portions of the sidewalls thereof, while avoiding spraying or dripping oil onto the flange of the tray. By some approaches, the oil is a liquid oil that is sprayable at refrigeration temperatures, though in some configurations the spraying occurs at between about 80° F. to about 140° F. Suitable oils include, for example, one or more of canola oil, soybean oil, safflower oil, sunflower oil, peanut oil, corn oil, winterized olive oil, and combinations thereof. In some configurations, the oil includes an emulsifier, such as, e.g., lecithin, monoglycerides, diglycerides, polysorbates, sodium stearoyl lactylate, and combinations thereof. By applying 1420 the oil with the emulsifier before depositing the mixed batter, the oil and emulsifier are applied in between the food product and the tray to assist with evacuation of the food product after baking and reheating.

After the oil is applied, the process 1400 deposits 1430 the mixed formula or batter into the cavities of the tray. In one exemplary embodiment, the mixture is deposited in a manner that prevents splashing, splattering, or dripping of the mixture onto the flange. Indeed, the nozzle aims to place the mixed formula directly onto the bottom of the cavities. In addition, the starch mentioned above is helpful in preventing, the mixed batter from splashing onto the flange, as well as helping suspend inclusions in some formulas. By one approach, the mixed batter is deposited at a temperature of typically below 45° F. to reduce the opportunity for splatter.

In step 1440, the mixed formula is thermally processed or cooked in one or more ovens, similar to those described above. By one illustrative approach, the cooking or bake step 1440 denatures the proteins, kills pathogens, creates a pleasant mouthfeel, and creates a browned surface on a portion of the top of the food product, such as by using the baking oven system 1330 described above. While the baking may be done in a variety of manners, the parameters mentioned above are calibrated to create a pleasing mouthfeel without overbaking or bubbling the product such that it might puff upward and contaminate the flange.

After baking 1440, the trays are transferred 1450 to a clean room for further processing. Since the food product is cook, cooled, shipped, and reheated in the tray, a high degree of care is taken to ensure that no pathogens or other contaminants are introduced into the tray. Accordingly, the step of cooling 1450 the food trays and sealing 1470 of the food product package generally occur in the clean room. As noted above, the step of cooling 1460 is done in a manner to prevent condensation from developing on the tray or product itself or on the cooling equipment to prevent any condensation from dripping onto the product or tray. For example, multiple zones or modules may be employed to drive the temperature down in a manner that avoids condensation buildup. In addition, the process 1400 typically does not require that the flange of the tray be wiped before sealing the film thereto because the cooler has intense condensation control (e.g., possibly using multiple dehumidifiers, with lots of air circulation, to thereby remove moisture from the cooler).

More particularly, in some configurations, the cooling step 1450 is employed to drive the temperature of the food product from about 190° F. to about 38° F. to 29° F. without creating any condensation on the product or on the equipment. As suggested, this may he accomplished by having the product advance through one or more chilled zones, while on a conveyor belt.

Once the food product is cooled 1460, the food product is sealed within the tray. Further, the process 1400 also may include exposing 1465 the film to a UV light treatment apparatus to prevent any microbes or germs from being sealed into the package. For example, a plurality of UV lamps may be disposed adjacent or on the sealing equipment to treat the film before it is sealed onto the flange of the tray having the food product therein. In some embodiments, the film is exposed to the UV light for between about 1-20 seconds at a distance of about 5-50 min. In some configurations, the film is exposed for between about 2-10 seconds at a distance of about 10-20 mm. In one exemplary installation, the film is about 50 mm from the UV light for about 4 seconds. In other approaches, a one log reduction can be achieved at a 20 mm distance for 4 seconds.

By one approach, the sealing 1470 of the food product within the tray includes sealing a clear film or film with graphics thereon to the flat flange of the tray with pressure and heat. In operation the sealer may be a vertical or horizontal sealing apparatus. As discussed above, the process 1400 is specifically designed to limit contamination of the flange and any deformations thereto that might make it difficult for the film to seal to the flange. For example, irregularities in the shape of the flange may create leakers or points where air and/or water may destroy the seal between the film and the flange of the tray. In addition, the tray also is configured to limit potential deformations of the flange as well. For example, the flange may include beveled corners that limit the opportunity for the flange to acquire an irregular non-linear configuration.

After the product is sealed, the product in the trays may be marked/labeled, packed, and ship 1480 to consumers. Before consumption, consumers are instructed to reheat the food product in the same tray before removing the food product from the tray for consumption.

In addition to examples with egg products discussed above, the formed tray and process described herein may also be employed with other food products. For example, the formed tray and process for baking and sealing a food product within the formed tray may also be utilized with baked goods such as muffins, breads, cakes, pretzels, and/or granola products, among a myriad of other foods.

### EXAMPLES

The following examples are intended to illustrate the food products and methods provided herein and not to limit or otherwise restrict the disclosure. Unless indicated otherwise, all parts, ratios, and all percentages are based on weight.

### Example 1

Egg products are prepared according to the process described above and in reference to FIG. 13. In a first mixer, 10.8% water, 11.9% Neufchatel cheese, 1.1% milk powder, 20.3% liquid egg whites, 53.2% liquid whole eggs, and 2.7% dry ingredients (2.5% starch (instant waxy corn starch (Novation Prima 350)), 0.2% salt, and no more than 650 ppm Nisaplin®) are combined and mixed to create an egg batter. The water has a temperature of no more than about 45° F. Using water of higher temperature water (e.g., room temperature or higher) can generate too much thickness via hydration of the starch.

The egg batter is then conveyed to a further blender and combined with inclusions to provide a mixture of 64% egg batter, 9% meat (e.g., ham), 13.5% cheese, 5% red peppers, 5% green peppers, and 3.5% yellow onions to form an egg mixture.

The liquid egg mixture is then pumped to a hold tank before being pumped to a tray depositor and deposited into trays according to the process described in FIG. 13. The trays are then conveyed to an oven. The egg mixture is baked for about 19 minutes at a temperature of about 370° F. to provide a fully cooked egg product. The egg mixture generally loses about 5% to 7% moisture during baking. The remainder of the process proceeds according to the method shown in FIG. 13.

### Example 2

A hashed brown potato product may also be prepared and dispensed into the formed trays described herein. Exemplary potato products include 55-65 percent shredded potatoes, 10-20% bacon bits (or other meat), 5-15% cheese, 5-15% other inclusions (e.g., vegetables), up to about 3% oil, and up to about 1% salt.

Potato shreds (e.g., 1/10″× 3/16″×natural length) may be either fully dehydrated or dehydrofrozen. Fully dehydrated shreds may be rehydrated with water (30-40% of final potato weight) prior to being utilized. Dehydrofrozen potatoes (40% max reduced moisture) will be thawed prior to being mixed with other ingredients. Potato shreds will comprise the majority of the finished good and they will be providing a crispy texture after going through the baking process.

In one approach, all ingredients except the bacon are mixed together. Once the mixture has been blended, it is deposited into the trays to form the hash brown patties. Each hash brown patty is topped with a bacon “crust” and baked until a crispy exterior is achieved. In an alternative approach, some or all of the bacon can be dispersed throughout the hash brown. The remaining steps of the process proceed according to the method shown in FIG. 13

In one embodiment, a packaged food product includes: a formed tray including: a first cavity, a second cavity adjacent the first cavity, a peripheral flange surrounding the first and second cavities, the peripheral flange having beveled corners, and a rigid bridge recessed below the peripheral flange and extending between the first and second cavities, a first end of the rigid bridge forming a first concave section and a second end of the rigid bridge forming a second concave section, wherein the rigid bridge is reinforced with ribbing; a food product disposed within the formed tray; and a flexible film having an upper surface and a lower surface, the lower surface having a sealant disposed thereon, wherein the lower surface of the flexible film is hermetically sealed to the peripheral flange to seal the food product within the formed tray.

In some embodiments, the first cavity further includes a first base and a first sloped sidewall, the first sloped sidewall extending from the peripheral flange to the first base and forming at least a portion of the first cavity; and wherein the second cavity includes a second base and a second sloped sidewalk the second sloped sidewall extending from the peripheral flange to the second base and forming at least a portion of the second cavity.

In some configurations, the radius of curvature of the first concave section and the second concave is between about 2 and about 5.

By some approaches, the rigid bridge extends from a first lengthwise side of the peripheral flange to a second lengthwise side of the peripheral flange.

In some embodiments, the first concave section is integrally connected to a first lengthwise side of the peripheral flange and the second concave section is integrally connected to a second lengthwise side of the peripheral flange.

In some configurations, the peripheral flange is linear to permit the flexible film to be sealed thereto without openings.

By some approaches, the flexible film is sealed to the tray with an adhesive. It also may be heat and pressure sealed alone, or with an adhesive. In some embodiments, the first cavity and the second cavity are inverted dome-shaped.

In some configurations, the first cavity and the second cavity are reinforced with ribbing.

As noted above, in some configurations, the food product is an egg product. In addition, in some embodiments, other ingredients, such as shredded potato are the primari8y ingredient and a hash brown product may be produced.

In one illustrative approach, a formed tray for baking and transporting a food product includes a linear flange that permits sealing thereto after baking; a first cavity, the first cavity having a first base and a first sloped sidewall, the first sloped sidewall extending from the linear flange to the first base and forming at least a portion of the first cavity; a second cavity adjacent the first cavity, the second cavity having a second base and a second sloped sidewall, the second sloped sidewall extending from the linear flange to the second base and forming at least a portion of the second cavity; a rigid bridge, the rigid bridge recessed below the linear flange and extending between the first cavity and the second cavity, a first end of the rigid bridge forming a first concave section of the linear flange and a second end of the rigid bridge forming a second concave section of the linear flange, wherein the rigid bridge is reinforced with ribbing; and a flexible film, the flexible film having an upper surface and a lower surface, the lower surface having a sealant disposed thereon, wherein the lower surface of the flexible film is hermetically sealed to the linear flange to seal a food product within the tray after baking.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A process for preparing a food product packaged in a formed tray, the formed tray comprising at least one cavity and an upper peripheral flange, the process comprising:
blending a raw egg mixture;
applying a coating of oil to a base of a formed tray having at least one cavity with an upper peripheral flange, wherein the base is disposed a distance below the upper peripheral flange, which has beveled corners;
depositing the blended, raw egg mixture into the at least one cavity of the formed tray;
heat treating the blended, raw egg mixture disposed in the formed tray;
transferring the heat-treated egg mixture in the formed tray to a clean room, the clean room having a positive air pressure and an air filtration system, the positive air pressure and air filtration system being effective to prevent the formation of condensation on the formed tray;
within the clean room, cooling the heat-treated egg mixture; and
hermetically sealing the cooled heat-treated egg mixture in the formed tray under vacuum with a nitrogen atmosphere, wherein a flexible film is sealed to the upper peripheral flange by applying heat and pressure.

2. The process of claim 1, wherein the process further includes:
adding at least one of a seasoning, food safety ingredient, and inclusion to the blended, raw egg mixture.

3. The process of claim 2 wherein the process includes adding the inclusion into the blended, raw egg mixture and the inclusion comprises at least one of a meat, a cheese, and a vegetable.

4. The process of claim 1 wherein the formed tray is a crystallized polyethylene terephthalate tray.

5. The process of claim 1 wherein the step of cooling the heat-treated egg mixture includes cooling the heat-treated egg mixture in a spiral cooler.

6. The process of claim 1 wherein the step of heat treating the blended, raw egg mixture in the formed tray includes baking the blended, raw egg mixture in the formed tray in an oven.

7. The process of claim 1 wherein the air filtration system includes a high efficiency particulate air filter.

8. The process of claim 1 wherein a sealant is disposed on a lower surface the flexible film.

9. The process of claim 1 wherein the blended raw egg mixture comprises about 65 to about 90% liquid egg product, up to about 20% fat source, up to about 5% protein source (by dry weight of the protein source), and up to about 7% starch.

10. The process of claim 1 wherein the blended raw egg mixture comprises about 65% to about 75% liquid egg, about 0.5% to about 1.5% milk powder as the protein source (by dry weight of the protein source), about 5% to about 20% soft cheese as the fat source, about 1% to about 7% starch, and water.

11. The process of claim 9 wherein the blended raw egg mixture further comprises up to about 1% salt and up to about 250 ppm nisin ingredient based on the heat-treated egg mixture when meat inclusions are added or no more than 600 ppm nisin ingredient based on the heat-treated egg mixture when meat inclusions are not included.

12. The process of claim 9 wherein the oil applied to the base of the formed tray further comprises an emulsifier.

13. A packaged food product comprising an egg mixture, wherein the packaged food product has been prepared by:
blending a raw egg mixture;
applying a coating of oil to at least one cavity of a formed tray;
depositing the blended, raw egg mixture into the at least one cavity of the formed tray;
heat treating the blended, raw egg mixture in the formed tray;
transferring the heat-treated egg mixture in the formed tray to a clean room, the clean room having a positive air pressure and an air filtration system, the positive air pressure and air filtration system being effective to prevent the formation of condensation on the formed tray;
within the clean room, cooling the heat-treated egg mixture; and
hermetically sealing the cooled heat-treated egg mixture in the formed tray under vacuum with a nitrogen atmosphere, wherein a flexible film is sealed to an upper peripheral flange of the formed tray by applying heat and pressure.

14. The packaged food product of claim 13 wherein the blended raw egg mixture comprises about 65 to about 90% liquid egg product, up to about 20% fat source, up to about 5% protein source (by dry weight of the protein source), and up to about 7% starch.

15. The packaged food product of claim 13 wherein the fat source comprises a soft cheese and the protein source comprises non-fat dry milk powder.

16. The packaged food product of claim 13 wherein the blended raw egg mixture comprises about 65% to about 75% liquid egg, about 0.5% to about 1.5% protein source (by dry weight of the protein source), about 5% to about 20% fat source, about 1% to about 7% starch, and water.

17. The packaged food product of claim 13 wherein the blended raw egg mixture further comprises up to about 1% salt and up to about 250 ppm nisin ingredient based on the heat-treated egg mixture when meat inclusions are added or no more than 600 ppm nisin ingredient based on the heat-treated egg mixture when meat inclusions are not included.

18. A ready-to-heat food product comprising a fully coked egg product prepared by baking a raw egg mixture comprising:
about 65% to about 75% liquid egg;
about 0.5% to about 1.5% protein source (by dry weight of the protein source);
about 5% to about 20% fat source;
about 1% to about 7% starch; and water.

19. The ready-to-heat food product of claim 18 wherein the raw egg mixture further comprises up to about 1% salt and up to about 250 ppm nisin ingredient based on the fully cooked egg product when meat inclusions are added or no more than 600 ppm nisin ingredient based on the fully cooked egg product when meat inclusions are not included.

20. The ready-to-heat food product of claim 18 wherein the protein source includes one or more of whey protein isolate, condensed milk, casein, powdered milk, non-fat dry milk powder, skim milk powder, condensed milk, ultrafiltered milk, skim milk, and plant-based milk.

21. The ready-to-heat food product of claim 20 wherein the protein source comprises non-fat dry milk powder.

22. The ready-to-heat food product of claim 18 wherein the fat source comprises a soft cheese.
